(19) United States
(12) Patent Application Publication
(10) Pub. No.: US 2021/0031323 A1
(43) Pub. Date: Feb. 4, 2021

(54) TOOL-MOUNTING-STATE ESTIMATION SYSTEM AND MACHINE TOOL

(71) Applicant: FANUC CORPORATION, Yamanashi (JP)

(72) Inventor: Gaku ISOBE, Yamanashi (JP)

(21) Appl. No.: 16/901,128

(22) Filed: Jun. 15, 2020

(30) Foreign Application Priority Data
Jul. 31, 2019 (JP) 2019-140798

(51) Int. Cl. B23Q 17/12; B23Q 17/00

(52) U.S. Cl. CPC B23Q 17/12; B23Q 17/006; B23Q 17/005

(57) ABSTRACT

A tool-mounting-state estimation system includes: a measuring tool including a body section having a tapered external surface common with a tapered external surface of a tool and a vibrating source that is mounted on the body section and that generates vibration; a sensor that is provided on a spindle for drawing the measuring tool thereinto so that the tapered external surface of the measuring tool comes into close contact with a tapered internal surface of the spindle and that detects the vibration generated by the vibrating source when the vibration propagates towards the spindle via the tapered external surface and the tapered internal surface; and an estimation unit for estimating a mounting state of the tool on the basis of the vibration detected by sensor.

### CROSS-REFERENCE TO RELATED APPLICATIONS

This application is based on and claims priority to Japanese Patent Application No. 2019-140798, filed on Jul. 31, 2019, the entire content of which is incorporated herein by reference.

### FIELD OF THE INVENTION

The present disclosure relates to a tool-mounting-state estimation system and a machine tool.

### BACKGROUND OF THE INVENTION

There are well-known machine tools in which the tapered external surface of a tool is brought into close contact with the tapered internal surface of a spindle of the machine tool through the operation of a draw bar provided on the spindle, thus fixing the tool to the spindle (refer to, for example, Japanese Unexamined Patent Application, Publication No. 2015-9283).

### SUMMARY OF THE INVENTION

One aspect of this disclosure is directed to a tool-mounting-state estimation system including: a measuring tool including a body section having a tapered external surface common with a tapered external surface of a tool and a vibrating source that is mounted on the body section and that generates vibration; a sensor that is provided on a spindle and that detects vibration, wherein the measuring tool is drawn into the spindle so that the tapered external surface of the measuring tool comes into close contact with a tapered internal surface of the spindle, and the vibration is generated by the vibrating source and propagates towards the spindle via the tapered external surface and the tapered internal surface; and an estimation unit that estimates a mounting state of the tool on a basis of the vibration detected by the sensor.

### BRIEF DESCRIPTION OF THE DRAWINGS

FIG. 1 is a diagram showing the entire configuration of a tool-mounting-state estimation system and a machine tool according to one embodiment of the present disclosure.

FIG. 2 is a longitudinal sectional view showing a state in which a measuring tool is mounted on a spindle of the machine tool in FIG. 1.

FIG. 3 is an entire configuration diagram showing a state before the measuring tool on a turret is mounted on the spindle of the machine tool in FIG. 1.

FIG. 4 is an entire configuration diagram showing a state after the measuring tool on the turret is mounted on the spindle of the machine tool in FIG. 1.

FIG. 5 is a block diagram showing an arithmetic operation unit of the tool-mounting-state estimation system in FIG. 1.

### DESCRIPTION OF EMBODIMENT(S) OF THE INVENTION

A tool-mounting-state estimation system 1 and a machine tool 100 according to one embodiment of the present disclosure will now be described with reference to the drawings.

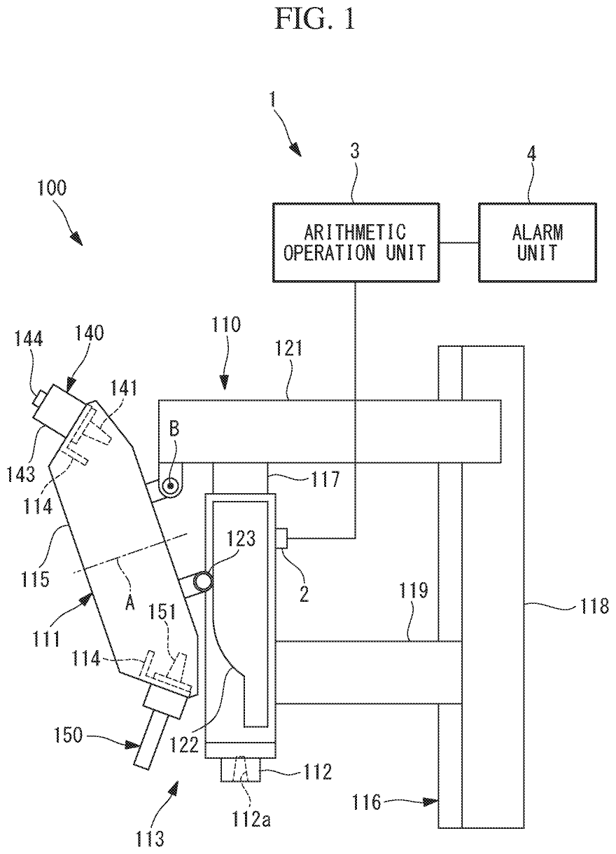

As shown in FIG. 1, the machine tool 100 according to this embodiment includes a machine tool main body 110 and the tool-mounting-state estimation system 1 according to this embodiment.

The machine tool main body 110 includes: a tool magazine 111 for accommodating a plurality of tools 150 and a measuring tool 140 (described later); a spindle 112 on which one of the tools 150 or the measuring tool 140 in the tool magazine 111 is mounted and that performs machining or measurement; and a tool exchange device 113 for exchanging the tool 150 or the measuring tool 140 between the spindle 112 and the tool magazine 111.

The tool magazine 111 includes a disc-shaped turret 115 having a plurality of grips 114 that are arranged in the circumferential direction with a space therebetween. The turret 115 is revolvable about a central axis line A, and each of the grips 114 detachably holds a tool 150. The measuring tool 140 is held, in the same manner as each of the tools 150, by one of the grips 114.

As shown in FIG. 1, the spindle 112 is supported by a spindle head 117 that is supported so as to be movable in the vertical direction by means of a linear-motion mechanism 116. The linear-motion mechanism 116 includes: a base 118 that extends in the vertical direction and that is fixed to the floor surface; and a slider 119 movable relative to the base 118 in the vertical direction, and the spindle head 117 is fixed to the slider 119.

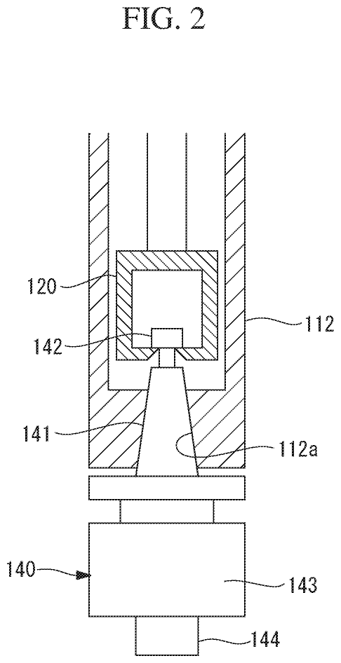

As shown in FIG. 2, the spindle 112 includes, at a lower section thereof, a tapered internal surface 112a with which a tapered external surface 141 or 151 of a tool 150 or the measuring tool 140 is brought into close contact and also includes a draw bar 120 that detachably grips a pull stud 142 of the tool 150 or the measuring tool 140 and that pulls the pull stud 142 upward. The spindle 112 performs machining with the tool 150, whose tapered external surface 151 is brought into close contact with the tapered internal surface 112a by means of the draw bar 120, by rotationally driving the tool 150 about a vertical axial line by means of a motor.

The tool exchange device 113 controls the turret 115 and the linear-motion mechanism 116. The turret 115 is supported by a support member 121 extending from the base 118 of the linear-motion mechanism 116 and is supported so as to be swivelable about a horizontal swiveling axial line B. A cam 122 is provided on a side surface of the spindle head 117, and the turret 115 includes a cam follower 123 that operates in conformance with the cam 122.

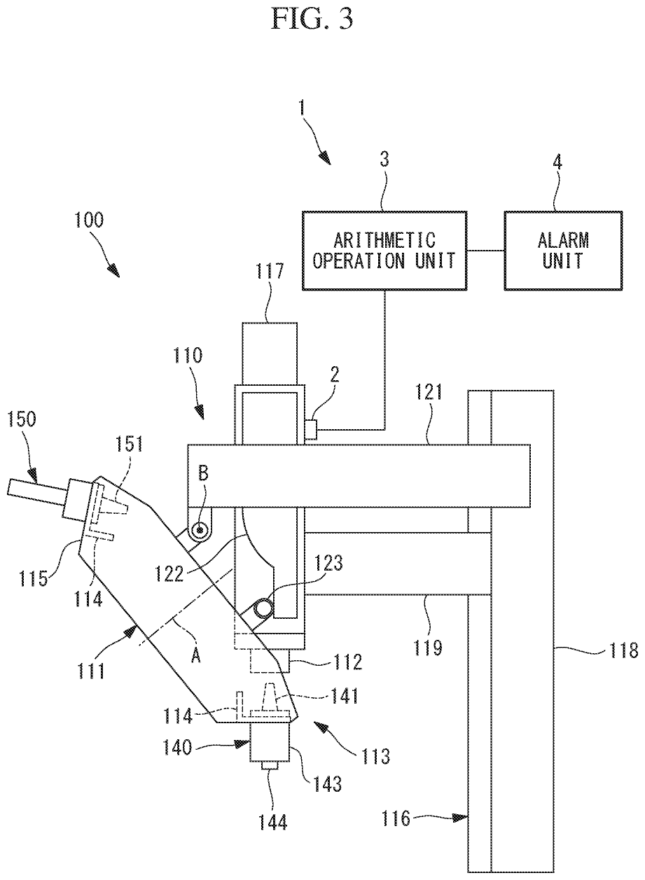

As shown in FIG. 3, the tool exchange device 113 lifts the spindle head 117 to the highest position through the operation of the linear-motion mechanism 116 in a state in which a tool 150 or the measuring tool 140 to be mounted on the spindle 112 is arranged at the lowest position by rotating the turret 115. By doing so, the turret 115 swivels about the swiveling axial line B, and the tool 150 or the measuring tool 140 to be mounted is arranged vertically below the spindle 112.

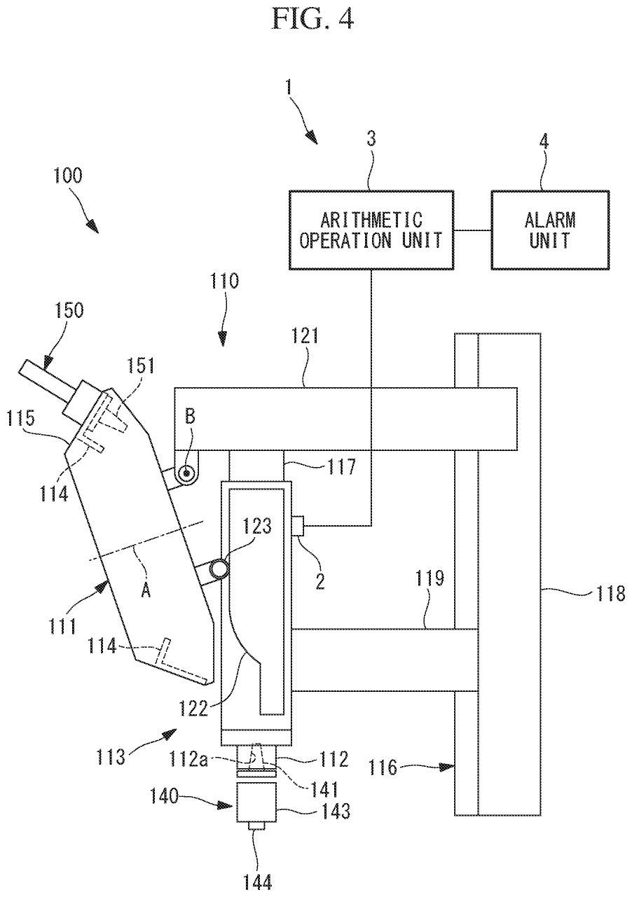

By lowering the spindle head 117 in this state, the tool 150 or the measuring tool 140 is inserted into the spindle 112 such that the tapered external surface 141 or 151 of the tool 150 or the measuring tool 140 is brought into close contact with the tapered internal surface 112a of the spindle 112, and the tool 150 or the measuring tool 140 is then mounted on the spindle 112 through the operation of the draw bar 120. Then, as shown in FIG. 4, the cam follower 123 moves in conformance with the cam 122 by further lowering the spindle head 117, thus causing the turret 115 to be swiveled and the tool 150 or the measuring tool 140 to be handed over from the grip 114 to the spindle 112.

As shown in FIG. 1, the tool-mounting-state estimation system 1 according to this embodiment includes: a sensor 2 provided on the spindle 112 of the machine tool main body 110; the measuring tool 140 detachably mounted on the spindle 112; an arithmetic operation unit 3 connected to the sensor 2; and an alarm unit 4 connected to the arithmetic operation unit 3. The sensor 2 is, for example, an acceleration sensor.

As shown in FIG. 2, the measuring tool 140 includes: a body section 143 including the tapered external surface 141 and the pull stud 142, which are common with those of the other tools 150; and a piezoelectric element (vibrating source) 144 mounted on the body section 143. As a result of being supplied with power from a battery (not shown in the figure), the piezoelectric element 144 generates vibration composed of, for example, a sine wave having a prescribed frequency.

In a state in which the measuring tool 140 is mounted on the spindle 112, the vibration generated by the piezoelectric element 144 of the measuring tool 140 propagates to the spindle 112 via the tapered external surface 141 and the tapered internal surface 112a and is then detected by the sensor 2.

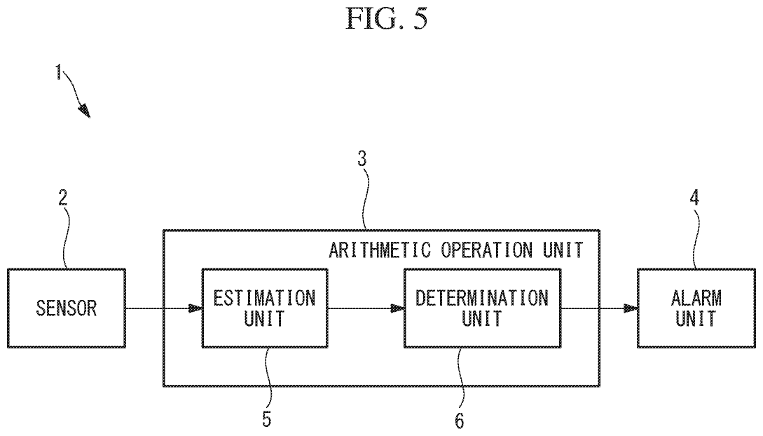

The arithmetic operation unit 3 is composed of a processor and a memory and, as shown in FIG. 5, includes an estimation unit 5 and a determination unit 6.

The estimation unit 5 estimates the mounting state of the measuring tool 140 on the basis of the vibration detected by the sensor 2.

More specifically, the estimation unit 5 performs frequency analysis on the vibration detected by the sensor 2 and calculates, as the degree of close contact between the tapered external surface 141 and the tapered internal surface 112a, the ratio of the amplitude of vibration having the same frequency as the input vibration generated by the piezoelectric element 144 with respect to the amplitude of the input vibration.

In addition, the estimation unit 5 also calculates a resonance frequency obtained as a result of the frequency analysis.

The determination unit 6 is composed of a processor and a memory and determines whether the calculated degree of close contact is less than or equal to a predetermined tolerance.

In addition, the determination unit 6 determines whether or not the calculated resonance frequency is below a threshold in response to a predetermined resonance frequency. The predetermined resonance frequency can be measured in advance by means of the measuring tool 140 that is mounted in a state in which the draw bar 120 and the tapered internal surface 112a are not degraded.

In the case where the calculated degree of close contact is less than or equal to the tolerance, the tapered external surface 141 of the measuring tool 140 and the tapered internal surface 112a of the spindle 112 are not brought into sufficiently close contact with each other. Thus, it is expected that a sufficiently high degree of close contact will not also be achieved when a tool 150 is mounted instead of the measuring tool 140.

Also, the cause of a decrease in the degree of close contact can be estimated by determining whether or not the resonance frequency is below the threshold.

More specifically, in the case where the degree of close contact decreases and the resonance frequency also decreases, it can be estimated that there is high probability of the drawing force having decreased due to deterioration of the draw bar 120. On the other hand, in the case where the degree of close contact decreases but the resonance frequency does not decrease, it can be estimated that there is high probability of the spindle 112 having the tapered internal surface 112a being worn down or having chips bitten between the tapered surfaces.

When the determination unit 6 determines that the degree of close contact is less than or equal to the tolerance, the alarm unit 4 reports this. The alarm unit 4 may be anything, including a monitor, a speaker, a lighting device, etc.

Also, as a result of the alarm unit 4 reporting a determination result made by the determination unit 6, an operator can become aware of a decrease in the degree of close contact between the tapered external surface 141 or 151 and the tapered internal surface 112a, as well as a rough cause for the decrease, thereby preventing machining from continuing in a state in which the tool 150 is not securely mounted on the spindle 112.

In other words, according to the tool-mounting-state estimation system 1 and the machine tool 100 of this embodiment, the measuring tool 140, which is normally mounted on the turret 115, can be quickly mounted on the spindle 112, as required or periodically, thus facilitating the measurement of the degree of close contact. This allows simple and early-stage detection of a deterioration in the mounting state of a tool 150 on the spindle 112. In addition, an advantage is afforded in that by analyzing vibration detected by the sensor 2, it is possible to determine whether deterioration in the mounting state has been caused by wear of the tapered internal surface 112a of the spindle 112 or biting of chips, or deterioration of the draw bar 120.

Note that although this embodiment has been described by way of an example where the piezoelectric element 144 is used as the vibrating source, instead of this, a hammering device may be used.

In this embodiment, when the determination unit 6 determines that the degree of close contact calculated by the estimation unit 5 is less than or equal to the predetermined tolerance, the alarm unit 4 reports this. Instead of this, the present invention may include a time estimation unit (not shown in the figure), which stores the degree of close contact calculated by the estimation unit 5 each time it is calculated and which estimates a time at which the degree of close contact will become less than or equal to the tolerance on the basis of an over-time change in the stored degree of close contact.

The time estimation unit affords an advantage in that a measure for improving the mounting state can be taken at an earlier stage because the time estimation unit can estimate the time at which the degree of close contact will become less than or equal to the tolerance before machining accuracy decreases as a result of that time being actually reached.

In addition, the tolerance and threshold can be set to arbitrary values.

1. A tool-mounting-state estimation system comprising:
a measuring tool including a body section having a tapered external surface common with a tapered external surface of a tool and a vibrating source that is mounted on the body section and that generates vibration;
a sensor that is provided on a spindle and that detects vibration, wherein the measuring tool is drawn into the spindle so that the tapered external surface of the measuring tool comes into close contact with a tapered internal surface of the spindle, and the vibration is generated by the vibrating source and propagates towards the spindle via the tapered external surface and the tapered internal surface; and
an estimation unit that estimates a mounting state of the tool on a basis of the vibration detected by the sensor.

2. The tool-mounting-state estimation system according to claim 1, wherein the estimation unit estimates, as the mounting state, a degree of close contact between the tapered external surface and the tapered internal surface on a basis of a ratio between an amplitude of the vibration generated by the vibrating source and an amplitude of the vibration detected by the sensor.

3. The tool-mounting-state estimation system according to claim 1, wherein the estimation unit estimates, as the mounting state, a decrease in a force for drawing the tapered external surface onto the tapered internal surface on a basis of a resonance frequency component of the detected vibration.

4. The tool-mounting-state estimation system according to claim 1, wherein the vibrating source comprises a piezoelectric element.

5. The tool-mounting-state estimation system according to claim 2, further comprising:
a determination unit that determines whether the degree of close contact estimated by the estimation unit is less than or equal to a tolerance; and
an alarm unit that reports that the degree of close contact is less than or equal to the tolerance when so determined by the determination unit.

6. The tool-mounting-state estimation system according to claim 2, further comprising:
a memory unit that stores the degrees of close contact estimated at time intervals; and
a time estimation unit that estimates a time at which the degree of close contact will become less than or equal to a tolerance on a basis of an over-time change in the degrees of close contact stored in the memory unit.

7. The tool-mounting-state estimation system according to claim 6, further comprising:
an alarm unit that reports the time estimated by the time estimation unit.

8. A machine tool comprising:
a sensor; and
an estimation unit that estimates a mounting state of a tool on a basis of vibration detected by the sensor,
wherein the sensor is provided on a spindle for drawing a measuring tool thereinto so that a tapered external surface of the measuring tool comes into close contact with a tapered internal surface of the spindle, the measuring tool including a vibrating source that is mounted on a body section having the tapered external surface common with a tapered external surface of the tool and that generates vibration, and
wherein the sensor detects the vibration that is generated by the vibrating source in a state in which the measuring tool is mounted and that propagates towards the spindle via the tapered external surface and the tapered internal surface.
